(19) United States
(12) Patent Application Publication
(10) Pub. No.: US 2025/0163985 A1
(43) Pub. Date: May 22, 2025

(54) PISTON PILOT VALVE ASSEMBLY AND FREQUENCY SENSITIVE SHOCK ABSORBER HAVING SAME

(71) Applicant: HL MANDO CORPORATION, Gyeonggi-do (KR)

(72) Inventor: Wonseok HAN, Gyeonggi-do (KR)

(21) Appl. No.: 18/424,861

(22) Filed: Jan. 28, 2024

(30) Foreign Application Priority Data
Nov. 20, 2023 (KR) 10-2023-0160299

(51) Int. Cl. F16F 9/32; F16F 9/512

(52) U.S. Cl. CPC F16F 9/3214; F16F 9/5126

(57) ABSTRACT

A piston pilot valve assembly used to vary a damping force of a frequency sensitive shock absorber according to an embodiment of the present disclosure includes: a piston pilot housing comprising a hollow cylindrical shape with both ends bent and extended toward a center, with a piston pilot chamber formed in a portion of an interior, and a pair of piston pilot valves accommodated between both bent and extended ends of the piston pilot housing and each covering the piston pilot chamber at both ends of the piston pilot housing.

### CROSS-REFERENCE TO RELATED APPLICATIONS

This application claims benefit and priority to Korean Patent Application No. 10-2023-0160299, filed on Nov. 20, 2023, with the Korean Intellectual Property Office, the disclosure of which is incorporated herein in its entirety by reference.

### TECHNICAL FIELD

The present disclosure relates to a piston pilot valve assembly and a shock absorber having the same, and more specifically, to a frequency sensitive shock absorber capable of simultaneously satisfy riding comfort and steering stability by controlling a damping force differently for high and low frequencies during a tension stroke of a piston valve.

### BACKGROUND

In general, a vehicle is installed with a shock absorber to improve riding comfort by attenuating impact or vibration applied to an axle from a road surface while the vehicle travels, and a shock absorber is used as one of such shock absorbers.

A shock absorber is called a damper. The shock absorber operates by responding to the vibration of a vehicle depending on road surface conditions. In this connection, the damping force generated from the shock absorber varies depending on the operating speed of the shock absorber, that is, depending on whether the operating speed is fast or slow.

A vehicle riding comfort and a driving stability may be controlled according to how to adjust a characteristic of a damping force generated in a shock absorber. Therefore, in designing a vehicle, it is of great important to adjust a characteristic of a damping force of a shock absorber.

For example, a shock absorber includes a cylinder filled with a working fluid such as oil, a reciprocating piston rod connected to a vehicle body, and a piston valve connected to a lower end of the piston rod to slide within the cylinder and control a flow of the working fluid.

The piston valve commonly used in the shock absorber is designed to have a constant damping characteristic at a high speed, a middle speed, and a low speed due to the use of a single flow passage. Accordingly, when intending to improve a riding comfort by reducing a low-speed damping force, middle-speed and high-speed damping forces may also be affected.

In addition, a conventional shock absorber has a structure in which a damping force varies according to a change in a speed of a piston, regardless of a frequency or a stroke. As such, the damping force that changes only according to the change in piston speed generates the same damping force in various road surface conditions, thus making it difficult to satisfy both the riding comfort and the steering stability.

### SUMMARY

An embodiment of the present disclosure provides a piston pilot valve assembly and a frequency sensitive shock absorber having the same capable of stably generating a damping force that changes according to changes in frequency and speed.

According to an embodiment of the present disclosure, the piston pilot valve assembly used to vary the damping force of a frequency sensitive shock absorber includes: a piston pilot housing including a hollow cylindrical shape with both ends bent and extended toward a center, with a piston pilot chamber formed in a portion of an interior; and a pair of piston pilot valves accommodated between both bent and extended ends of the piston pilot housing and each covering the piston pilot chamber at both ends of the piston pilot housing.

The piston pilot valve assembly may further include a pilot spacer that maintains a gap between the pair of piston pilot valves within the piston pilot chamber.

The pair of piston pilot valves each include a pilot disc whose overall diameter is larger than a diameter of a hole at the both bent and extended ends of the piston pilot housing, and a pilot sealing member coupled to an edge of the pilot disc and formed to contact an inner side surface of the piston pilot housing.

The both bent and extended ends of the piston pilot housing may be configured to prevent the pair of piston pilot valves from leaving the piston pilot housing.

The pair of piston pilot valves may include a first pilot valve disposed to face one end of the both bent and extended ends of the piston pilot housing, and a second pilot valve disposed to face the other end of the both bent and extended ends of the piston pilot housing.

The piston pilot valve assembly may further include a piston inlet disc located in the piston pilot chamber adjacent to the first pilot valve. In addition, the piston inlet disc may include at least one slit formed to allow a working fluid to flow into the piston pilot chamber.

The piston pilot valve assembly may further include a pilot retainer interposed between the second pilot valve and the other end of the both bent and extended ends of the piston pilot housing.

The pilot retainer may include: a first pilot retainer located inside the piston pilot housing and having a diameter larger than a diameter of a hole at the other end that is bent and extended of the piston pilot housing; and a second pilot retainer that is in contact with the first pilot retainer, has a diameter smaller than the diameter of the hole at the other end that is bent and extended of the piston pilot housing, and is located in the hole at the other end.

A bypass hole may be formed through a side surface of the piston pilot housing to communicate with an inside of the piston pilot housing outside the piston pilot chamber.

In addition, the frequency sensitive shock absorber according to an embodiment of the present disclosure includes: a piston rod that reciprocates within a cylinder and is formed with a piston injection flow passage communicating with a rebound chamber; a piston valve mounted on the piston rod, partitioning the cylinder into a compression chamber and the rebound chamber, and generating a damping force; a piston main retainer coupled to the piston rod and having a piston main chamber in communication with the piston injection flow passage; and a piston pilot valve assembly coupled to the piston rod between the piston valve and the piston main retainer to vary the damping force generated by opening and closing the piston main chamber according to a size of frequency during a tension stroke. In addition, the piston pilot valve assembly includes: a piston pilot housing including a hollow cylindrical shape with both ends bent and extended toward a center, with a piston pilot chamber in communication with the piston injection flow passage formed in a portion of the interior; and a pair of piston pilot valves that are accommodated between the both bent and extended ends of the piston pilot housing, each of which covers the piston pilot chamber at both ends of the piston pilot housing, and closes the piston main chamber when a pressure of the piston pilot chamber rises above a preset pressure.

The piston pilot valve assembly may further include a pilot spacer fitted to the piston rod to maintain a gap between the pair of piston pilot valves within the piston pilot chamber.

The pair of piston pilot valves each include: a pilot disc through which the piston rod is coupled through a center, and whose overall diameter is larger than a diameter of a hole at the both bent and extended ends of the piston pilot housing; and a pilot sealing member coupled to an edge of the pilot disc and formed to contact an inner side surface of the piston pilot housing.

The pair of piston pilot valves may include a first pilot valve disposed to face one end facing the main retainer among the both bent and extended ends of the piston pilot housing, and a second pilot valve disposed to face the other end facing the piston valve among the both bent and extended ends of the piston pilot housing.

The piston pilot valve assembly may further include a piston inlet disc located in the piston pilot chamber adjacent to the first pilot valve and connecting the piston injection flow passage and the piston pilot chamber, and be configured so that an inflow rate of the working fluid flowing into the piston pilot chamber through the piston inlet disc during the tension stroke is relatively limited compared to the inflow rate of the working fluid flowing into the piston main chamber according to the size of the frequency.

The piston pilot valve assembly may further include a pilot retainer interposed between the other end of the piston pilot housing and the second pilot valve. In addition, the pilot retainer may include: a first pilot retainer located inside the piston pilot housing and having a diameter larger than a diameter of a hole at the other end that is bent and extended of the piston pilot housing; and a second pilot retainer that is in contact with the first pilot retainer, has a diameter smaller than the diameter of the hole at the other end that is bent and extended of the piston pilot housing, and is located in the hole at the other end.

A bypass hole may be formed through a side surface of the piston pilot housing to communicate with an inside of the piston pilot housing outside the piston pilot chamber.

In addition, as a stroke of the piston rod during a low-frequency tension stroke operates at a relatively larger width than during a high-frequency tension stroke, an inflow rate of a working fluid flowing into the piston pilot chamber increases and the pressure of the piston pilot chamber increases. When the pressure of the piston pilot chamber rises above a preset pressure, the pilot valve may be configured to close the piston main chamber to prevent the working fluid from moving to the compression chamber through the piston main chamber.

In addition, as a stroke of the piston rod during a high-frequency tension stroke operates at a relatively smaller width than during a low-frequency tension stroke, an inflow rate of a working fluid flowing into the piston pilot chamber decreases and the pressure of the piston pilot chamber decreases. When the pressure of the piston pilot chamber falls below a preset pressure, the piston pilot valve may be configured to open to allow the working fluid to move to the compression chamber through the piston main chamber.

The piston main chamber may be formed by opening an area of one surface of the piston main retainer opposite the piston pilot valve assembly, an inflow hole connected to the piston injection flow passage formed on the other surface of the piston main retainer opposite to the one surface may be formed, and the inflow hole may be connected to the piston main chamber.

The frequency sensitive shock absorber may further include a piston nut fastened to an end of the piston rod that sequentially penetrates the piston valve, the piston pilot valve assembly, and the piston main retainer, and a piston washer provided between the other surface of the piston main retainer and the piston nut.

According to an embodiment of the present disclosure, a piston pilot valve assembly and a frequency sensitive shock absorber having the same can stably generate a damping force that effectively changes according to changes in frequency and speed.

### BRIEF DESCRIPTION OF THE DRAWINGS

FIG. 1 is a cross-sectional view of a piston pilot valve assembly and a frequency sensitive shock absorber having the same according to an embodiment of the present disclosure.

FIG. 2 is a perspective view of a piston inlet disc used in the piston pilot valve assembly of FIG. 1.

FIGS. 3 and 4 are cross-sectional views for explaining the operating state of the frequency sensitive shock absorber of FIG. 1.

FIG. 5 is a graph showing the operational effect of a piston pilot valve assembly and a frequency sensitive shock absorber having the same according to an embodiment of the present disclosure.

### DETAILED DESCRIPTION

Hereinafter, embodiments of the present disclosure will be described in detail with reference to the accompanying drawings so that those with ordinary skill in the art to which the present disclosure pertains may easily carry out the embodiments. The present disclosure may be implemented in various different ways, and is not limited to the embodiments described herein.

It is noted that the drawings are schematic, and are not illustrated based on actual scales. Relative dimensions and proportions of parts illustrated in the drawings are exaggerated or reduced in size for the purpose of clarity and convenience in the drawings, and any dimension is just illustrative but not restrictive. The same reference numerals designate the same structures, elements or components illustrated in two or more drawings in order to exhibit similar characteristics.

Embodiments of the present disclosure illustrate ideal embodiments of the present disclosure in detail. As a result, various modifications of the drawings are expected. Therefore, the embodiments are not limited to specific forms in regions illustrated in the drawings, and for example, include modifications of forms by the manufacture thereof.

In addition, unless otherwise defined, all technical and scientific terms used in the present specification have meanings generally understood by those skilled in the art to which the present disclosure pertains. All terms used in the present specification are selected for the purpose of more clearly explaining the present disclosure but not selected to restrict the scope of the present disclosure.

In addition, the expressions “include,” “provided with,” “have” and the like used in the present specification should be understood as open-ended terms connoting the possibility of inclusion of other embodiments unless otherwise mentioned in a phrase or sentence including the expressions.

In addition, a singular expression can include the meanings of the plurality unless otherwise mentioned, and the same applies to a singular expression stated in the claims.

The terms “first,” “second,” and the like used in the present specification are used to identify a plurality of constituent elements from one another and are not intended to limit the order or importance of the relevant constituent elements.

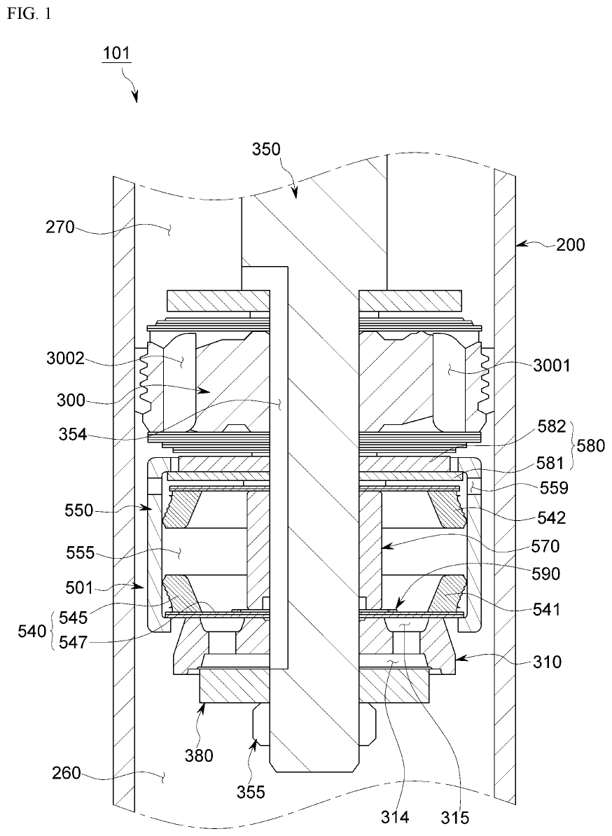

Hereinafter, a piston pilot valve assembly 501 and a frequency sensitive shock absorber 101 having the same according to an embodiment of the present disclosure will be described with reference to FIGS. 1 to 5. Herein, a shock absorber is called a damper. For example, the shock absorber may be installed in a vehicle and used to absorb and attenuate impact or vibration applied to an axle from a road surface while a vehicle travels.

As illustrated in FIG. 1, the frequency sensitive shock absorber 101 includes a cylinder 200, a piston rod 350, a piston valve 300, a piston main retainer 310, and a piston pilot valve assembly 501.

In addition, the frequency sensitive shock absorber 101 may further include a piston nut 335 and a piston washer 380.

The cylinder 200 may have a cylindrical shape to form a space therein, and the inside of the cylinder 200 is filled with a working fluid. Herein, the inside of the cylinder 200 may be partitioned into a compression chamber 260 and a rebound chamber 270 by the piston valve N. For example, based on the piston valve 300, the rebound 300, which will be described below. chamber may be disposed at an upper portion of the cylinder 200, and the compression chamber 260 may be disposed at a lower portion of the cylinder 200.

The piston rod 350 may reciprocate within the cylinder 200. For example, one side of the piston rod 350 may be located inside the cylinder 200, and the other side of the piston rod 350 may extend outside the cylinder 200 and be connected to a vehicle body or a wheel side of a vehicle. In addition, the piston valve 300, the piston main retainer 310, and the piston pilot valve assembly 501 are mounted on one side of the piston rod 350.

In addition, a piston injection flow passage 354 communicating with the rebound chamber 270 is formed in the piston rod 350. Specifically, the piston injection flow passage 354 may be formed in a long slit form along a length direction of the piston rod 350 on one outer peripheral surface of the piston rod 350.

The piston valve 300 is mounted on the piston rod 350, and partitions the inside of the cylinder 200 into a compression chamber 260 and a rebound chamber 270. In addition, the piston valve 300 controls the movement of working fluid between the compression chamber 260 and the rebound chamber 270 to generate a damping force.

In other words, the piston valve 300 may be provided to reciprocate inside the cylinder 200 filled with working fluid together with the piston rod 350 in a state in which the piston rod 350 is penetrated and coupled. In addition, the piston valve 300 may include a plurality of piston compression flow passages 3001 formed through a direction connecting the compression chamber 260 and the rebound chamber 270 to allow fluid to move between the compression chamber 260 and the rebound chamber 270, and a plurality of piston tension flow passages 3002.

For example, during a tension stroke, a pressure of the rebound chamber 270 rises relatively higher than that of the compression chamber 260. Due to this increase in pressure of the rebound chamber 270, the working fluid filled in the rebound chamber 270 moves to the compression chamber 260 through the tension flow passage 3002 of the piston valve body 300. Conversely, during a compression stroke, a pressure of the compression chamber 260 rises relatively higher than that of the rebound chamber 270. Due to this increase in pressure of the compression chamber 260, the working fluid filled in the compression chamber 260 moves to the rebound chamber 270 through the compression flow passage 3001 of the piston valve body 300.

The piston main retainer 310 is coupled to the piston rod 350. For example, the piston main retainer 310 may be coupled to the piston rod 350 in a direction where the piston valve 300 faces the compression chamber 260 with the piston pilot valve assembly 501, which will be described later, interposed therebetween. In other words, the piston pilot valve assembly 501 and the piston main retainer 310 may be sequentially coupled to the piston rod 350 in a direction where the piston valve 300 faces the compression chamber 260.

In addition, the piston main retainer 310 has a piston main chamber 315 formed to communicate with the piston injection flow passage 354 formed in the piston rod 350. Specifically, the piston main chamber 315 may be formed by opening an area of one surface of the piston main retainer 310 that faces the piston pilot valve assembly 501. In addition, an inflow hole 314 connected to the piston injection flow passage 354 may be formed on the other surface of the piston main retainer 310, which is opposite to the one surface. The inflow hole 314 formed on the other surface of the piston main retainer 310 may be connected to the piston main chamber 315 formed on one surface of the piston main retainer 310 through an internal flow passage.

As such, the piston main retainer 310 forms the piston main chamber 315 and the inflow hole 314 on different surfaces that are separated from each other and does not form them all on one surface, thereby improving the overall mechanical strength of the piston main retainer 310. For example, unlike the first embodiment of the present disclosure, when both the piston main chamber 315 and the inflow hole 314 are formed on the same one surface of the piston main retainer 310, as the mechanical strength of the surface where both the piston main chamber 315 and the inflow hole 314 are formed is weakened, the main retainer 310 may have a weakened ability to withstand the load applied in an axial direction and may be easily damaged. After the piston rod 350 penetrates the piston valve body 300, the piston pilot housing 330, and the piston main retainer 310, a significant load may be applied in an axial direction when a piston nut 355, which will be described later, is fastened. However, when both the piston main chamber 315 and the inflow hole 314 are formed on the same one surface of the piston main retainer 310, the piston main retainer 310 may not be able to withstand the load and may be damaged.

However, according to the second embodiment of the present disclosure, the piston main retainer 310 may secure overall improved mechanical strength by forming the piston main chamber 315 on one surface and forming the inflow hole 314 communicating with the piston inlet flow passage 354 on the other surface opposite to the one surface to disperse the same. Accordingly, when the piston rod 350 penetrates the piston valve body 300, the piston pilot housing 330, and the piston main retainer 310 and then couple the same through the piston nut 355, the piston main retainer 310 may stably withstand the load applied in an axial direction.

The piston pilot valve assembly 501 is coupled to the piston rod 350 between the piston valve 300 and the piston main retainer 310 to vary the damping force generated by opening and closing the piston main chamber 315 depending on a size of frequency during a tension stroke.

In other words, the piston valve 300 generates a constant damping force regardless of the size of the frequency, while the piston pilot valve assembly 501, together with the piston main retainer 310 in which the piston main chamber 315 is formed, generates a damping force that changes depending on the size of the frequency during a tension stroke.

Specifically, the piston pilot valve assembly 501 includes a piston pilot housing 550 and a pair of piston pilot valves 540.

In addition, the piston pilot valve assembly 501 may further include a pilot spacer 570, a piston inlet disc 590, and a pilot retainer 580.

The piston pilot housing 550 has a hollow cylindrical shape with both ends bent and extended toward a center, with a piston pilot chamber 555 communicating with the piston injection flow passage 354 formed in a portion of the interior. In this connection, the piston pilot chamber 555 may be connected to the piston injection flow passage 354 through the piston inlet disc 590, which will be described later.

In addition, the piston pilot housing 550 may be disposed to be spaced apart from the piston rod 350 and surround the piston rod 350.

The pair of piston pilot valves 540 are accommodated between the both bent and extended ends of the piston pilot housing 550 and each cover the piston pilot chamber 555 at both ends of the piston pilot housing 550. In other words, the space between the pair of piston pilot valves 540 within the piston pilot housing 550 may become the piston pilot chamber 555. In addition, when the pressure of the piston pilot chamber 555 rises above a preset pressure, the pair of piston pilot valves 540 closes the piston main chamber 315 formed in the piston main retainer 310.

Herein, the preset pressure may be set in various ways depending on the performance required for the frequency sensitive shock absorber 101, and may be a pressure that balances the pressure of the piston main chamber 315 and the pressure of the piston pilot chamber 555. In addition, the preset pressure may be determined according to the thickness and quantity of at least one slit 593 and pilot disc 547 formed in a piston inlet disc 590, which will be described later. A plurality of pilot discs 547 may be stacked not only in a first pilot valve 541 but also in a second pilot valve 542 to set a pressure.

Specifically, the pair of piston pilot valves 540 may include the first pilot valve 541 disposed to face one end facing the main retainer 310 among the both bent and extended ends of the piston pilot housing 550, and the second pilot valve 542 disposed to face the other end facing the piston valve 310 among the both bent and extended ends of the piston pilot housing 550. In other words, the first pilot valve 541 of the pair of piston pilot valves 540 may be configured to open and close the piston main chamber 315.

The piston pilot valve 540 may operate to close the piston main chamber 315 by the pressure of the working fluid flowing into the piston pilot chamber 555 during a low-frequency tension stroke. When the piston main chamber 315 is closed by the piston pilot valve 540, the working fluid in the rebound chamber 270 is prevented from moving to the compression chamber 260 through the piston injection flow passage 354 and the piston main chamber 315, and the working fluid moves only through the piston valve 300.

In addition, during a high-frequency tension stroke, the pressure of the working fluid flowing into the piston pilot chamber 555 is relatively lower than the pressure of the working fluid flowing into the piston main chamber 315, and the force of the piston pilot valve 540 to block the piston main chamber 315 weakens, so that the piston pilot valve 540 is pushed by the pressure of the piston main chamber 315, opening the piston main chamber 315. When the piston main chamber 315 is opened, the working fluid in the rebound chamber 270 may move to the compression chamber 260 through the piston injection flow passage 354 and the piston main chamber 315 in addition to the piston valve 300. In this connection, during a high-frequency tension stroke, the pressure of the working fluid flowing into the piston pilot chamber 555 is relatively lower than the pressure of the working fluid flowing into the piston main chamber 315. This is because the working fluid flowing into the piston pilot chamber 555 flows through the piston inlet disc 590 and the inflow rate is limited.

Specifically, for example, during a low-frequency tension stroke, when the flow rate of the working fluid flowing into the piston pilot chamber 555 through the piston inlet disc 590 is sufficient to smoothly form pressure in the piston pilot chamber 555, and when the pressure between the piston pilot chamber 555 and the piston main chamber 315 is in equilibrium, the piston pilot valve 540 is blocked, preventing the piston main chamber 315 from opening.

However, during a high-frequency tension stroke, the flow rate of the working fluid flowing into the piston pilot chamber 555 is limited due to the piston inlet disc 590, and the pressure of the piston pilot chamber 555 is lower than the pressure of the piston main chamber 315. As a result, the force of the pilot valve 540 blocking the piston main chamber 315 is weakened, and the piston pilot valve 540 is pushed by the pressure of the piston main chamber 315, causing the working fluid in the rebound chamber 270 to move to the compression chamber 260 through the piston injection flow passage 354 and the piston main chamber 315.

As such, during a low-frequency tension stroke, the working fluid in the rebound chamber 270 moves to the compression chamber 260 through the piston valve 300, while during a high-frequency tension stroke, the working fluid in the rebound chamber 270 also moves to the compression chamber 260 through the piston injection flow passage 354 and the piston main chamber 315 along with the piston valve 300. Hence, the frequency sensitive shock absorber 101 may vary the damping force generated according to the change in frequency.

In addition, the pair of piston pilot valves 540 may each include the pilot disc 547 and a pilot sealing member 545.

The pilot disc 547 may have the piston rod 350 coupled through the same at a center, and its overall diameter may be larger than the diameter of the holes at the both bent and extended ends of the piston pilot housing 550.

The pilot sealing member 545 may be coupled to an edge of the pilot disc 547 and may be formed to contact an inner side surface of the piston pilot housing 550.

The pilot disc 547 may be deformed according to a change in pressure of the piston pilot chamber 555, which opens and closes the pilot main chamber 315. However, even when the pilot disc 547 is deformed, the pilot sealing member 545 maintains contact with the inner side surface of the piston pilot housing 550 to prevent unnecessary loss of pressure in the piston pilot chamber 555 due to leakage of working fluid.

For example, the pilot disc 547 may be made of a metal material, and the pilot sealing member 545 may be made of a resin material, that is, rubber.

However, when the pilot sealing member 545 is made of a resin material, due to the nature of the material, the pilot sealing member 545 is worn when used for a long time, and the contact force or contact area with the piston pilot housing 550 is reduced, causing the piston pilot valve 540 to deviate from its normal position or leak working fluid. As a result, the pressure in the piston pilot chamber 555 is lost, which may cause a decrease in the damping force of the frequency sensitive shock absorber 101.

However, according to an embodiment of the present disclosure, the pair of piston pilot valves 540 are accommodated between the both bent and extended ends of the piston pilot housing 550, and the both bent and extended ends of the piston pilot housing 550 limit the movement of the piston pilot valve 540 to suppress wear of the pilot sealing member 545. Moreover, even when wear occurs on the pilot sealing member 545, the contact state between the pilot sealing member 545 and the piston pilot housing 550 may be maintained and the piston pilot valve 540 may be prevented from leaving its normal position.

Accordingly, the overall durability and lifespan of the frequency sensitive shock absorber 101 may be improved.

The both bent and extended ends of the piston pilot housing 550 may prevent the pair of piston pilot valves 540 from leaving the piston pilot housing 550, so that even before the piston pilot valve assembly 501 is mounted on the piston rod 350, some parts of the piston pilot valve assembly 501 may be maintained in a state that is not easily separated.

Accordingly, the overall assembly of the frequency sensitive shock absorber 101 may be greatly improved.

The pilot spacer 570 may be inserted into the piston rod 350 to maintain the gap between the pair of piston pilot valves 540 within the piston pilot chamber 555.

The piston inlet disc 590 may be located in the piston pilot chamber 555 adjacent to the first pilot valve 541 of the pair of piston pilot valves 540, and may connect the piston injection flow passage 354 and the piston pilot chamber 555.

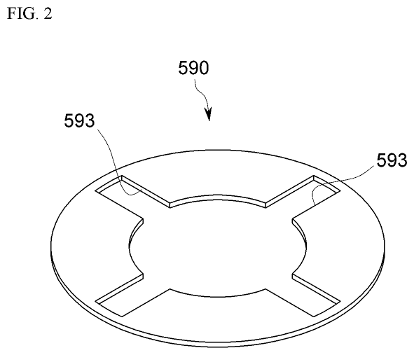

Specifically, as illustrated in FIG. 2, the piston inlet disc 590 may include at least one slit 593 formed to communicate the piston pilot chamber 555 with the piston injection flow passage 354 formed in the piston rod 350 to allow working fluid to flow into the piston pilot chamber 555.

The slit 593 of the piston inlet disc 590 may be formed from a hollow portion of the piston inlet disc 590 through which the piston rod 350 penetrates to a position in communication with the piston pilot chamber 555. Accordingly, the piston injection flow passage 354 and the piston pilot chamber 555 may be connected through the slit 593 of the piston inlet disc 590. In addition, the flow rate of the working fluid flowing into the piston pilot chamber 555 may be adjusted by adjusting the number and size of the slits 393 of the piston inlet disc 590.

Thus, depending on the size of frequency, the inflow flow rate of the working fluid flowing into the piston pilot chamber 555 through the piston inlet disc 590 during a piston tension stroke may be relatively limited compared to the inflow rate of the working fluid flowing into the piston main chamber 315. For example, as the pressure of the working fluid flowing into the piston injection flow passage 354 increases, the inflow rate of the working fluid flowing into the piston pilot chamber 555 decreases compared to that of the working fluid flowing into the piston main chamber 315.

The pilot retainer 580 may be interposed between the other end of the piston pilot housing 550 and the second pilot valve 542 of the piston pilot valve 540.

Specifically, the pilot retainer 580 may include a first pilot retainer 581 and a second pilot retainer 582.

The first pilot retainer 581 may have a diameter larger than the diameter of the hole at the other end that is bent and extended of the piston pilot housing 550 and may be located inside the piston pilot housing 550.

The second pilot retainer 582 may be in contact with the first pilot retainer 581, may have a diameter smaller than the diameter of the hole at the other end that is bent and extended of the piston pilot housing 550, and may be located in the hole at the other end.

With this structure, the pilot retainer 580 may block the hole at the other end that is bent and extended of the piston pilot housing 550 or greatly limit the movement of working fluid through the hole at the other end.

A bypass hole 559 may be formed through a side surface of the piston pilot housing 550 so that the inside of the piston pilot housing 550 outside the piston pilot chamber 555 communicates with the outside of the piston pilot housing 550.

As the pressure of the piston pilot chamber 555 fluctuates, the pair of piston pilot valves 540 may also be deformed. In this connection, working fluid may be easily introduced or discharged from inside the piston pilot housing 550 to the space outside the piston pilot chamber 555 through the bypass hole 559 formed on the side surface of the piston pilot housing 550.

In particular, when the aforementioned pilot retainer 580 blocks the hole at the other end that is bent and extended of the piston pilot housing 550, the working fluid may not move smoothly. The bypass hole 559 resolves this defect.

The piston nut 355 may be fastened to the end of the piston rod 350 that sequentially penetrates the piston valve 300, the piston pilot valve assembly 501, and the piston main retainer 310. In other words, the piston nut 355 may prevent the piston valve 300, the piston pilot valve assembly 501, and the piston main retainer 310 from being deviated from the piston rod 350.

The piston washer 380 may be coupled to the piston rod 350 so as to be interposed between the piston nut 355 and the other surface of the piston main retainer 310. In addition, the piston washer 380 may be interposed between an upper portion of the piston valve 300 and the piston rod 350.

With this configuration, the piston pilot valve assembly 501 and the frequency sensitive shock absorber 101 having the same according to an embodiment of the present disclosure may stably generate a damping force that effectively changes depending on frequency and speed changes.

For example, by adjusting the inflow rate of the working fluid that passes through the piston injection flow passage 354 during a tension stroke into the piston pilot chamber 335 and the piston main chamber 315, by implementing similar damping force at low and high frequencies in a low-speed section, and varying the damping force according to low and high frequencies in a mid-to-high speed section, it is possible to simultaneously satisfy the riding comfort and steering stability of a vehicle.

In particular, according to an embodiment of the present disclosure, in the piston pilot valve assembly 501, the pair of piston pilot valves 540 are accommodated between the both bent and extended ends of the piston pilot housing 550. Hence, as described above, the both bent and extended ends of the piston pilot housing 550 limit the movement of the piston pilot valve 540 to suppress wear of the pilot sealing member 545. Moreover, even when wear occurs on the pilot sealing member 545, the contact state between the pilot sealing member 545 and the piston pilot housing 550 may be maintained and the piston pilot valve 540 may be prevented from leaving its normal position. Accordingly, the overall durability and lifespan of the frequency sensitive shock absorber 101 may be improved.

In addition, the both bent and extended ends of the piston pilot housing 550 may prevent the pair of piston pilot valves 540 from leaving the piston pilot housing 550, so that even before the piston pilot valve assembly 501 is mounted on the piston rod 350, some parts of the piston pilot valve assembly 501 may be maintained in a state that is not easily separated. Accordingly, since the installation of the piston pilot valve assembly 501 on the piston rod 350 becomes easy, the overall assembly of the frequency sensitive shock absorber 101 may be greatly improved.

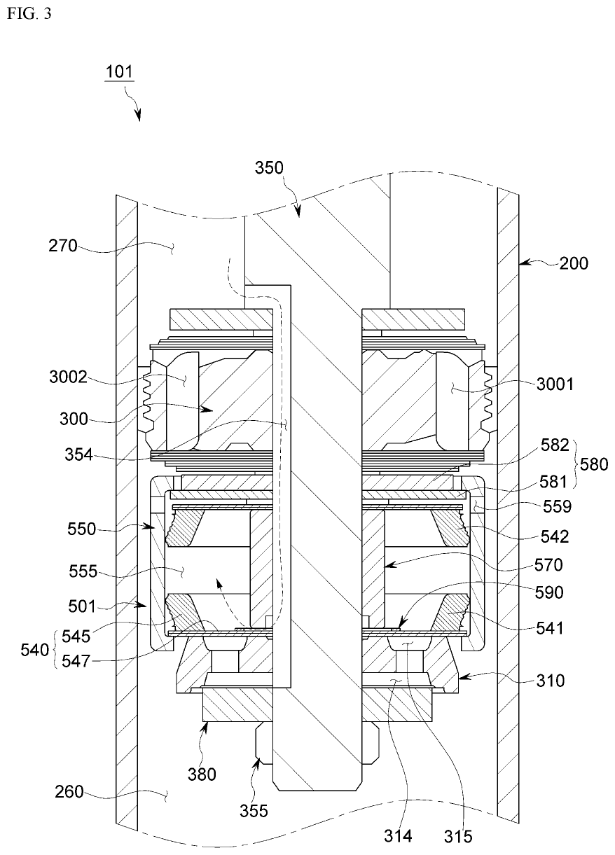

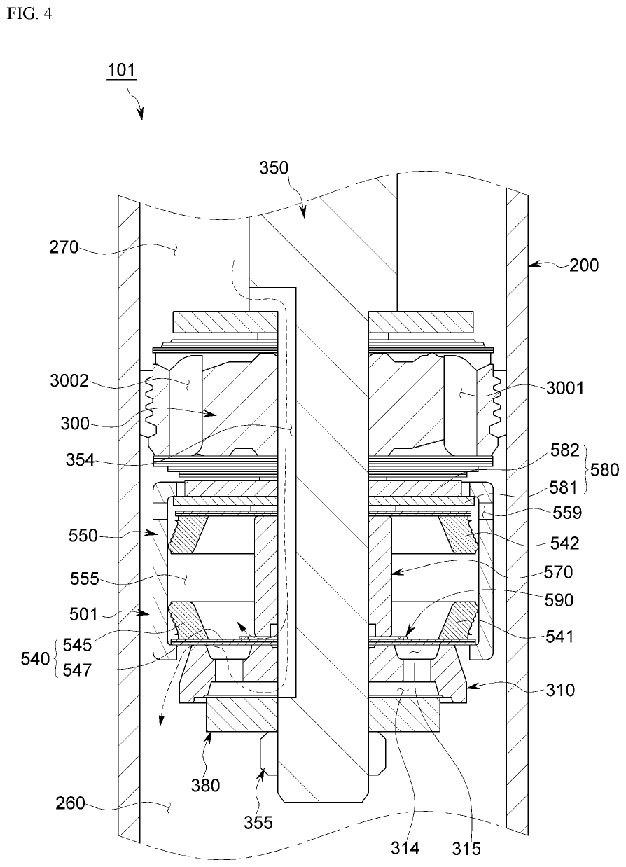

Hereinafter, with reference to FIGS. 3 and 4, the operating state of the piston pilot valve assembly 501 and the frequency sensitive shock absorber 101 having the same according to an embodiment of the present disclosure will be described in detail.

First, as illustrated in FIG. 3, as a stroke of the piston rod 350 during a low-frequency tension stroke operates at a relatively larger width than during a high-frequency tension stroke, the inflow rate of the working fluid flowing into the piston pilot chamber 555 increases and the pressure of the piston pilot chamber 555 increases.

As such, during a low-frequency tension stroke, the flow rate of the working fluid flowing into the piston pilot chamber 555 through the piston inlet disc 590 is sufficient to smoothly form pressure in the piston pilot chamber 555, and thus the pressure equilibrium between the piston pilot chamber 555 and the piston main chamber 315 prevents the piston main chamber 315 from opening.

In other words, when the pressure of the piston pilot chamber 555 rises above a preset pressure during a low-frequency tension stroke, the piston pilot valve 540 closes the piston main chamber 315 by the pressure of the working fluid flowing into the piston pilot chamber 555.

Herein, the preset pressure may be set in various ways depending on the performance required for the frequency sensitive shock absorber 101, and may, for example, be a pressure that balances the pressure of the piston main chamber 315 and the pressure of the piston pilot chamber 555. In addition, the preset pressure may be adjusted through the size of at least one slit 593 formed in the piston inlet disc 590.

Therefore, during a low-frequency tension stroke, the working fluid in the rebound chamber 270 moves to the compression chamber 260 through the piston valve 300, and is unable to move through the piston injection flow passage 354 and the piston main chamber 315. Accordingly, the frequency sensitive shock absorber 101 generates a relatively high damping force during a low-frequency tension stroke.

Next, as illustrated in FIG. 4, during a high-frequency tension stroke, as a stroke of the piston rod 350 operates at a relatively smaller width than during a low-frequency tension stroke, the inflow rate of the working fluid flowing into the piston pilot chamber 555 decreases and the pressure of the piston pilot chamber 555 decreases.

As such, during a high-frequency tension stroke, the inflow rate of the working fluid flowing into the piston pilot chamber 555 is limited due to the piston inlet disc 590, and thus the pressure of the piston pilot chamber 555 becomes lower than the pressure of the piston main chamber 315. As a result, the force of the piston pilot valve 540 blocking the piston main chamber 315 is weakened, and the piston pilot valve 540 is pushed by the pressure of the piston main chamber 315, opening the piston main chamber 315. In addition, the working fluid in the rebound chamber 270 may move to the compression chamber 260 through the piston injection flow passage 354 and the piston main chamber 315.

In other words, during a high-frequency tension stroke, when the pressure of the piston pilot chamber 555 falls below a preset pressure, the force of the pilot valve 540 blocking the piston main chamber 315 is weakened by the pressure of the working fluid flowing into the piston pilot chamber 555, and thus the piston pilot valve 540 is pushed by the pressure of the piston main chamber 315.

Accordingly, during a high-frequency tension stroke, the working fluid in the rebound chamber 270 may move to the compression chamber 260 not only through the piston valve 300 but also through the piston injection flow passage 354 and the piston main chamber 315. In other words, during a high-frequency tension stroke, the piston injection flow passage 354 and the piston main chamber 315 form a bypass flow passage through which the working fluid may move from the rebound chamber 270 to the compression chamber 260.

Accordingly, the frequency sensitive shock absorber 102 generates a relatively low damping force during a high-frequency tension stroke.

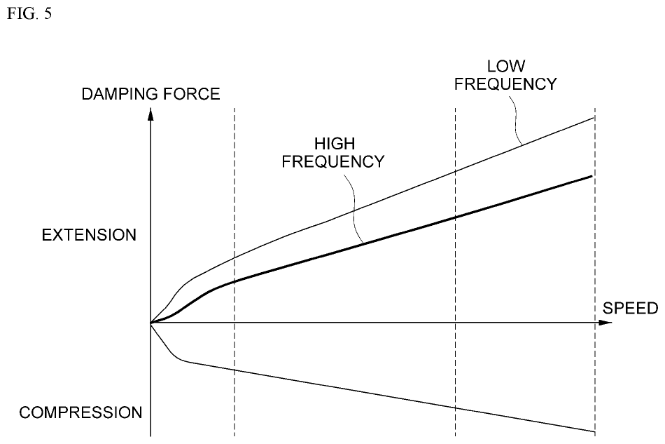

FIG. 5 is a graph showing the variable damping force of the frequency sensitive shock absorber 101 during a low-frequency tension stroke and a high-frequency tension stroke. As shown in FIG. 5, it can be seen the frequency sensitive shock absorber 101 prevents the damping force from decreasing during a low-frequency tension stroke, and that the damping force varies depending on the frequency in a mid-to-high-speed section.

As described above, the piston pilot valve assembly 501 and the frequency sensitive shock absorber 101 having the same according to an embodiment of the present disclosure may prevent a decrease in steering stability by preventing a decrease in damping force in a low-speed section during a low-frequency tension stroke, and may improve riding comfort by generating variable damping force for each frequency in a mid-to-high speed section.

In particular, the frequency sensitive shock absorber 101 according to an embodiment of the present disclosure may have improved durability and assembly ability as described above.

While the embodiments of the present disclosure have been described with reference to the accompanying drawings, those skilled in the art will understand that the present disclosure may be carried out in any other specific form without changing the technical spirit or an essential feature thereof.

Accordingly, it should be understood that the aforementioned embodiments are described for illustration in all aspects and are not limited, and the scope of the present disclosure shall be represented by the claims to be described below, and it should be construed that all of the changes or modified forms induced from the meaning and the scope of the claims, and an equivalent concept thereto are included in the scope of the present disclosure.

### DETAILED DESCRIPTION OF MAIN ELEMENTS

101: Frequency sensitive shock absorber
200: Cylinder
260: Compression chamber
270: Rebound chamber
300: Piston valve
3001: Piston compression flow passage
3002: Piston tension flow passage
310: Piston main retainer
314: Inflow hole
315: Piston main chamber
350: Piston rod
354: Piston injection flow passage
355: Piston nut
380: Piston washer
501: Piston pilot valve assembly
540: Piston pilot valve
541: First pilot valve
542: Second pilot valve
545: Pilot sealing member
547: Pilot disc
550: Piston pilot housing
555: Piston pilot chamber
559: Bypass hole
570: Pilot spacer
580: Pilot retainer
581: First pilot retainer
582: Second pilot retainer
590: Piston inlet disc
593: Piston inlet disc slit

What is claimed is:

1. A piston pilot valve assembly used to vary a damping force of a frequency sensitive shock absorber, the assembly comprising:
a piston pilot housing comprising a hollow cylindrical shape with both ends bent and extended toward a center, with a piston pilot chamber formed in a portion of an interior; and
a pair of piston pilot valves accommodated between both bent and extended ends of the piston pilot housing and each covering the piston pilot chamber at both ends of the piston pilot housing.

2. The assembly of claim 1, further comprising a pilot spacer that maintains a gap between the pair of piston pilot valves within the piston pilot chamber.

3. The assembly of claim 1, wherein the pair of piston pilot valves each comprises:
a pilot disc whose overall diameter is larger than a diameter of a hole at the both bent and extended ends of the piston pilot housing; and
a pilot sealing member coupled to an edge of the pilot disc and formed to contact an inner side surface of the piston pilot housing.

4. The assembly of claim 1, wherein the both bent and extended ends of the piston pilot housing are configured to prevent the pair of piston pilot valves from leaving the piston pilot housing.

5. The assembly of claim 1, wherein the pair of piston pilot valves comprises:
a first pilot valve disposed to face one end of the both bent and extended ends of the piston pilot housing; and
a second pilot valve disposed to face the other end of the both bent and extended ends of the piston pilot housing.

6. The assembly of claim 5, further comprising a piston inlet disc located in the piston pilot chamber adjacent to the first pilot valve, wherein the piston inlet disc comprises at least one slit formed to allow working fluid to flow into the piston pilot chamber.

7. The assembly of claim 5, further comprising a pilot retainer interposed between the second pilot valve and the other end of the both bent and extended ends of the piston pilot housing.

8. The assembly of claim 7, wherein the pilot retainer comprises:
a first pilot retainer located inside the piston pilot housing and having a diameter larger than a diameter of a hole at the other end that is bent and extended of the piston pilot housing; and
a second pilot retainer that is in contact with the first pilot retainer, has a diameter smaller than the diameter of the hole at the other end that is bent and extended of the piston pilot housing, and is located in the hole at the other end.

9. The assembly of claim 1, wherein a bypass hole is formed through a side surface of the piston pilot housing to communicate with an inside of the piston pilot housing outside the piston pilot chamber.

10. A frequency sensitive shock absorber, comprising:
a piston rod that reciprocates within a cylinder and is formed with a piston injection flow passage communicating with a rebound chamber;
a piston valve mounted on the piston rod, partitioning the cylinder into a compression chamber and the rebound chamber, and generating a damping force;
a piston main retainer coupled to the piston rod and having a piston main chamber in communication with the piston injection flow passage; and
a piston pilot valve assembly coupled to the piston rod between the piston valve and the piston main retainer to vary the damping force generated by opening and closing the piston main chamber according to a size of frequency during a tension stroke,
wherein the piston pilot valve assembly comprises:
a piston pilot housing comprising a hollow cylindrical shape with both ends bent and extended toward a center, with a piston pilot chamber in communication with the piston injection flow passage formed in a portion of an interior; and
a pair of piston pilot valves that is accommodated between both bent and extended ends of the piston pilot housing, each of which covers the piston pilot chamber at both ends of the piston pilot housing, and is configured to close the piston main chamber when a pressure of the piston pilot chamber rises above a preset pressure.

11. The absorber of claim 10, wherein the piston pilot valve assembly further comprises a pilot spacer fitted to the piston rod to maintain a gap between the pair of piston pilot valves within the piston pilot chamber.

12. The absorber of claim 10, wherein the pair of piston pilot valves each comprises:
a pilot disc through which the piston rod is coupled through a center, and whose overall diameter is larger than a diameter of a hole at the both bent and extended ends of the piston pilot housing; and
a pilot sealing member coupled to an edge of the pilot disc and formed to contact an inner side surface of the piston pilot housing.

13. The absorber of claim 10, wherein the pair of piston pilot valves comprises:
a first pilot valve disposed to face one end facing the main retainer among the both bent and extended ends of the piston pilot housing; and
a second pilot valve disposed to face the other end facing the piston valve among the both bent and extended ends of the piston pilot housing.

14. The absorber of claim 13, wherein the piston pilot valve assembly further comprises a piston inlet disc located in the piston pilot chamber adjacent to the first pilot valve and connecting the piston injection flow passage and the piston pilot chamber, and is configured so that an inflow rate of a working fluid flowing into the piston pilot chamber through the piston inlet disc during the tension stroke is relatively limited compared to the inflow rate of the working fluid flowing into the piston main chamber according to the size of the frequency.

15. The absorber of claim 13, wherein:
the piston pilot valve assembly further comprises a pilot retainer interposed between the other end of the piston pilot housing and the second pilot valve; and
the pilot retainer comprises:
a first pilot retainer located inside the piston pilot housing and having a diameter larger than a diameter of a hole at the other end that is bent and extended of the piston pilot housing; and
a second pilot retainer that is in contact with the first pilot retainer, has a diameter smaller than the diameter of the hole at the other end that is bent and extended of the piston pilot housing, and is located in the hole at the other end.

16. The absorber of claim 10, wherein a bypass hole is formed through a side surface of the piston pilot housing to communicate with an inside of the piston pilot housing outside the piston pilot chamber.

17. The absorber of claim 10, wherein:
as a stroke of the piston rod during a low-frequency tension stroke operates at a relatively larger width than during a high-frequency tension stroke, an inflow rate of a working fluid flowing into the piston pilot chamber increases and the pressure of the piston pilot chamber increases; and
when the pressure of the piston pilot chamber rises above a preset pressure, the pilot valve is configured to close the piston main chamber to prevent the working fluid from moving to the compression chamber through the piston main chamber.

18. The absorber of claim 10, wherein:
as a stroke of the piston rod during a high-frequency tension stroke operates at a relatively smaller width than during a low-frequency tension stroke, an inflow rate of a working fluid flowing into the piston pilot chamber decreases and the pressure of the piston pilot chamber decreases; and
when the pressure of the piston pilot chamber falls below a preset pressure, the piston pilot valve is configured to open to allow the working fluid to move to the compression chamber through the piston main chamber.

19. The absorber of claim 10, wherein:
the piston main chamber is formed by opening an area of one surface of the piston main retainer opposite the piston pilot valve assembly;
an inflow hole connected to the piston injection flow passage formed on the other surface of the piston main retainer opposite to the one surface is formed; and
the inflow hole is connected to the piston main chamber.

20. The absorber of claim 19, further comprising:
a piston nut fastened to an end of the piston rod that sequentially penetrates the piston valve, the piston pilot valve assembly, and the piston main retainer; and
a piston washer provided between the other surface of the piston main retainer and the piston nut.
